(19) United States
(12) Patent Application Publication
(10) Pub. No.: US 2016/0212020 A1
(43) Pub. Date: Jul. 21, 2016

(54) SELECTION OF RESOURCE PROVIDERS FOR MULTI-TENANCY PROVISION OF BUILDING BLOCKS

(71) Applicant: HEWLETT PACKARD ENTERPRISE DEVELOPMENT LP, Houston, TX (US)

(72) Inventors: Prashant Gupte, Sunnyvale, CA (US); Matthew S. Newman, Sunnyvale, CA (US); Stephane Herman Maes, Sunnyvale, CA (US)

(21) Appl. No.: 14/914,309

(22) PCT Filed: Sep. 4, 2013
(86) PCT No.: PCT/US2013/058048

§ 371 Date: Feb. 25, 2016

(51) Int. Cl. H04L 12/24

(52) U.S. Cl. CPC H04L 41/5054; H04L 41/0803; H04L 41/0883

(57) ABSTRACT

Process requests for services from users of a plurality of tenants, determine parameters to input into service designs based on each of the requests and each of the corresponding tenants, input the determined parameters into the service designs, select a specific resource provider of the building blocks at run time based on the parameters and the service designs, and instantiate the building blocks.

### BACKGROUND

A cloud service generally refers to a service that allows end recipient computer systems (thin clients, portable computers, smartphones, desktop computers, other applications, services or systems and so forth) to access a pool of hosted computing and/or storage resources (i.e., the cloud resources) and networks over a network (the Internet, for example) or a possible combination of these and other similarly built cloud services. In this manner, the host, a cloud service provider, may, for example, provide Software as a Service (SaaS) by hosting applications, Infrastructure as Service (IaaS) by hosting equipment (servers, storage components, network components, etc.), or a Platform as a Service (PaaS) by hosting a computing platform (operating system, middleware, data bases, autoscaling infrastructure, etc.).

A typical cloud service can incur charges on a demand basis, is managed by the cloud service provider and may be scaled (e.g., scaled according to desired storage capacity, processing power, network bandwidth) by the end user. The cloud service may be a public service (e.g., an Internet-based service) that is generally available to all potential users or a limited access private service that is provided over a private network (e.g., a business enterprise network) as well as a managed cloud service—private or hosted—(e.g., a virtual private cloud service) or a hybrid cloud service (a cloud service that is a combination of the above). Traditionally, when a user orders a cloud service, the user may manually perform various actions related to deploying and configuring software associated with the ordered cloud service (e.g., deployment of virtual machines (VMs), middleware, application software, application components) on the provisioned/instantiated infrastructure.

### BRIEF DESCRIPTION OF THE DRAWINGS

FIG. 1 is a flow diagram of an example of an environment for selection of resource providers for multi-tenancy provision of building blocks according to the present disclosure.

FIG. 2 illustrates an example of an environment for selection of resource providers for multi-tenancy provision of building blocks according to the present disclosure.

FIG. 3 illustrates an example of cloud service management for selection of resource providers for multi-tenancy provision of building blocks according to the present disclosure.

FIG. 4 illustrates an example of a flow chart for selection of resource providers for multi-tenancy provision of building blocks according to the present disclosure.

FIG. 5 illustrates an example of a system for selection of resource providers for multi-tenancy provision of building blocks according to the present disclosure.

FIG. 6 illustrates an example of a system for selection of resource providers for multi-tenancy provision of building blocks according to the present disclosure.

FIG. 7 illustrates a flow diagram of an example method for selection of resource providers for multi-tenancy provision of building blocks according to the present disclosure.

### DETAILED DESCRIPTION

In order to provide cloud services, an organization may employ a cloud service manager to offer and deliver (e.g., instantiate, provision, and deploy) services to manage the lifecycles of cloud services for end users. As used herein, managing the lifecycles of cloud services can include managing the building of a cloud service, ongoing management of an existing cloud service, reporting, metering, and/or auditing, for example. More particularly, a cloud service manager can orchestrate the use of application programming interfaces (APIs) of existing cloud services for managing the lifecycles of the existing cloud services and combinations of the existing cloud services for users of end systems (e.g., desktops, portable computers, smartphones, clients, thin clients, servers). A cloud service provisioning system can include and/or be in communication with a design component configured to create a service design for a cloud capability. The design component can be separate from the provisioning system and understood by a cloud service manager and can be able to reflect resources, offerings, etc. that a controller can provide. A service design can include a set of actions to instantiate the cloud capability as well as a collection of resources to be utilized in the instantiation of the cloud capability. An instantiation can include an instance of the capability (e.g., a deployed instance, an executed instance, etc.).

Depending on the particular implementation, the selection and ordering of cloud lifecycle management services may be performed by a given user (e.g., an administrator) for a group of end users (e.g., users of an enterprise), or the selection and ordering of the cloud capabilities may be performed by a given user (e.g., an Internet-based user or employee) for the given user's individual use. Users of the cloud service manager may select and order cloud capabilities through the cloud service manager. Cloud capabilities, as used herein, can refer to existing cloud services, combinations of existing cloud services and services that are provided by existing cloud resources, as well as lifecycle management of all these; as are offered and delivered by the cloud service manager (and described in the cloud design). The cloud capabilities may be provided by services that are in a “cloud.”

A cloud may be a public cloud (e.g., a cloud formed from an Internet-based network and which provides hosted cloud services that are generally available to members of the public), a private cloud (e.g., a cloud formed from a private, limited access network (such as an enterprise network) which provides hosted cloud services to a limited group of members), a virtual private cloud (e.g., a cloud formed from a public network providing hosted cloud services to a limited group of members), managed cloud and/or a hybrid cloud (e.g., a cloud formed from a combination of two or more of the aforementioned clouds). A hybrid cloud can be formed including a traditional and/or pre-existing data center. Examples of clouds, in accordance with the present disclosure, are not so limited, however, and a cloud may include a number of different types of, and/or combinations of, distributed computing systems.

In various examples of Cloud Based Provisioning systems, basic building blocks (e.g., server, storage, network, security, application install, etc.) can be created using resource providers. The resource providers, using their capabilities, can provide a plug-in and/or a fife cycle management action to be performed in order to provide a particular resource (e.g., a cloud service and/or an ability to implement a cloud service) in a particular cloud. Selecting which resource provider can be based on particular characteristics of the resource and/or the particular cloud. The provided resources can include software as a service (SaaS) offerings. When using SaaS, an entity may not acquire a license for the software nor arrange for it to be installed, hosted and managed. Such responsibilities can be performed by the organization offering the SaaS. In a previous example of an SaaS application, users can be groups of employees of a particular organization and that organization can be known as a tenant. The organization can be known as the owner of the application and the users can all share the application.

A single tenant application system can use one service design with a number of building blocks. A building block can include a server, storage capabilities (e.g., a database), a network, security capabilities, an application, a management of a life cycle of a resource, etc. For example, a 3-tiered application can include three building blocks combined to provide the 3-tiered application. A first building block can include a server and a database. A second building block can include a server and a web server. A third building block can include a server and an application server. The building blocks (e.g., the first, second, and third building blocks) can be joined logically and/or physically to provide the 3-tiered application. The single tenant application can use the first, second, and third building blocks exclusively. For example, the 3-tiered application can exclusively use the first, second, and third building blocks so that an additional provided resource may not be able to use the first, second, and third building blocks. This is in contrast to multi-tenancy provisioning where building blocks can be shared across a number of applications. For example, the first and second building blocks could be used by a second application and a third application, respectively.

Multi-tenancy refers to software architecture where a single instance of a software runs on a server, serving multiple client organizations (tenants). With multi-tenancy architecture, a software application can virtually partition data and configurations and each client organization can interact with a customized virtual application instance. Multi-tenancy architecture can allow a software as a service (SaaS) architecture to operate properly. In a non-SaaS architecture, an application that can support multiple users can provide for users that are at the same organization. In SaaS architecture, the organization can be a tenant and may not be an owner. A user of an organization can be designated as belonging to a tenant associated with the organization Users of different organizations can belong to different tenants. A multi-tenancy model can provide each tenant with an experience of owning their own copy of the application even though they may share the application with a number of tenants (e.g., organizations). The multi-tenancy model can include offering support to each user within a tenant. The multi-tenancy model can allow a number of users of a tenant to share a resource within the tenant. The multi-tenancy model can isolate resources provided across tenants (e.g., to different tenants) while allowing shared resources within a tenant. The multi-tenancy model can isolate and/or share resources per tenant and across tenants based on multi-tenancy agreements and/or policies. These multi-tenancy models can be considered as a multi-tenant application. In a multi-tenant application, the building blocks can be shared across many applications while remaining shared only among users of a same tenant for example if this is what is requested (e.g. isolation of instances across tenant) or shared across all if isolation is not needed. The multi-tenancy model can be used with a dynamic provider system to select a resource for multi-tenant application deployment. A dynamic provider system can include a specified generic resource provider that is a representation (e.g., abstract representation, digital representation) of a provider during design time.

As used herein, a generic resource provider represents a cloud resource in the abstract, according to its associated function, which is not tied to a specific type, location, or resource. For instance, the service design may include a generic resource provider of a server type (e.g., a generic server resource), without restricting the resource to a specific physical server assembly or even restricting it to a physical or virtual implementation. A number of different types of generic resource providers can be available for use in a given service design, including for example, server resources, network structures, data storage, software applications, monitoring, and management interfaces. The generic resource provider can select a specific resource provider at run time in order to allow flexibility in selection of providers.

There can be a number of different multi-tenancies architectures. A first multi-tenancy architecture can include a virtualization in a cloud where a hardware is shared. A second multi-tenancy architecture can include a single application with separate databases per tenant. A third multi-tenancy architecture can include a single application and a shared database. The third multi-tenancy architecture can be an efficient method of allocating resources. The third multi-tenancy architecture can be combined with a generic resource provider architecture to select a specific resource provider. A fourth multi-tenancy architecture can include a number of applications provided per tenant on a same platform sharing common resources (e.g., database, platform, etc.).

The selection of a specific resource provider associated with a generic provider can be performed at run-time (e.g., when the design is executed, managed, monitored, and/or updated). Selecting a specific resource provider to perform a task at run-time instead of design time can provide a number of advantages, in accordance with examples of the present disclosure. For example, it allows a better separation of concerns between the various roles and functions. Once the design has been established, the underlying provider infrastructure can be changed without affecting a given service as the service can be established in the design. No change is needed to the service design even though the underlying infrastructure may be changed. All of the complexities of a specific resource provider and the policies that they support are abstracted to functional requirements, such that designers will work with one provider for a given resource type with a single set of offerings. The service deployment is controlled by modifying or adding to the set a business policy and/or quality of service (QoS) parameters in a service blueprint and offerings, which drives the selection of the specific resource provider. As used herein, a service blueprint includes a set of workflows, recipes, and/or scripts that correspond to particular lifecycle management actions that may be performed to orchestrate the APIs of the appropriate cloud resources for purposes of managing the lifecycle of a given cloud capability. A business policy can include a number of policies determined by an entity. For example, a policy can be that a particular department needs to share information. A business policy can be that a particular department may need a level of security due to a sensitive nature of the work.

The selection of a resource can include selection of a sub-portion (e.g., a slice) of the resource. The selection of the resource can be based on selection criteria and/or a multitenancy policy (e.g. whether the resource is for users of a same tenant or different tenants, whether the resource can be shared across tenants, etc. For example, a sub-portion can be designated for a particular business unit (e.g., financial, legal, regulatory, etc.). A sub-portion can be designated for a particular organization. Using only a sub-portion of the resource can allow for partitioning of business units and/or organizations in order to maintain privacy, confidential, etc. Using only a sub-portion can allow for more efficient use of the resource. In some example, the selection of a resource can be based on business policies and/or quality of service (QoS) parameters. The selection can be based on dependency tracking between various building blocks and composite abstract service definitions (e.g., dependencies such as use-of, part-of, depends-on, requires, etc. but are not limited to such aforementioned dependencies).

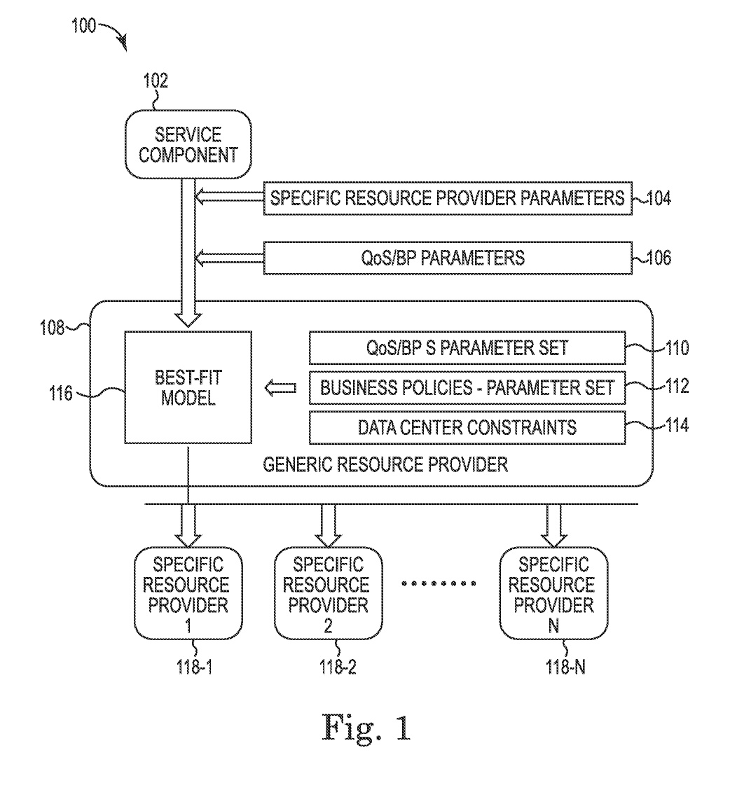

FIG. 1 is a flow diagram of an example of an environment 100 for providing network resources according to the present disclosure. The environment 100 can include a service design for a cloud capability in collaboration with a user. The service design can be designed by a designer. A service design can include a set of actions to instantiate the cloud capability, as well as, a collection of resources to be utilized in the instantiation of the cloud capability. For example, a service design action can include communicating with a service provider to provide and/or instantiate (or manage) a specific resource. A service design action can include updating and/or eliminating a service based on a change in a request from a user and/or a change in the service design based on a parameter and/or policy considerations. The service design can be associated with a document (e.g., as metadata) that describes actions to be carried out by the service design. The described actions can be within the service design and/or stored in a location as metadata separate from the service design. As used herein, a resource refers to a cloud resource and can include a server, data storage devices, network devices, security applications, an application install, a monitoring device, and/or a managing device. However, examples are not so limited and a resource can include a number of different software and/or hardware components.

In a number of examples of the present disclosure, a service design can be designed and includes a service component 102 that can be associated with parameters. The service design can be implemented as a cloud service. The service component can incorporate parameters 104 for a specific resource provider 118-1, 118-2, . . . , 118-N. The generic resource provider can be modeled as a generic representation of a component with parameters. When a request is received for a service (e.g., a user sending a request through a portal and/or from an application and/or system such as an application programming interface (API)), parameters associated with the request can be entered into a service blueprint (e.g., a service design). The parameters can include information provided by the request and/or contextual information (e.g., a tenant the user is a part of, a capacity of different providers, etc.). A specific resource provider parameter 104 can include a type of provider requested (e.g., storage space, processing speed, etc.).

The service component 102 can incorporate a number of parameters. The parameters can include Quality of Service (QoS) and/or business policy (BP) parameters 106. A parameter can include a number of considerations, such as Quality of Service (QoS) requirements, (e.g., an amount of storage space, bandwidth, priority, overall load of system and processing capacity) business policies, and/or contextual considerations (e.g., type of application and security requirements, location, who is allowed to use what (e.g., tiered offerings)). A parameter can include a categorical parameter, an ordinal value, an interval value, and/or a ratio value, for example.

The service design can include a generic resource provider 108 (e.g., resource providers), rather than associating the provided services with specific cloud resources. The concept of a generic resource provider is discussed further in previously filed PCT application PCT/US12/67596. A parameter can be used to determine which generic resource provider to select. In such examples, the generic resource provider 108 can be selected based on a particular service to be provided, and a number of parameters (e.g., QoS parameter set 110, business policy parameter set 112, and Data Center constraints 114) associated with the generic resource provider 108. The generic resource provider 108 can include a best-fit model 116 (e.g., software, logic) to incorporate parameters (e.g., QoS parameter set 110, business policy parameter set 112, and Data Center constraints 114). The generic resource provider 108 can use a number of parameters to select a specific resource provider (e.g., 118-1, 118-2, . . . , 118-N). As used herein, a parameter can include a consideration and/or constraint used to identify a specific resource provider from a number of different generic resource providers.

As used herein, a generic resource provider 108 (e.g., a generic resource provider) represents a cloud resource in representational form in the design, according to its associated function, which is not tied to a specific type, location, or resource. For instance, the service design may include a generic resource provider of a server type (e.g., a generic server resource), without restricting the resource to a specific physical server assembly and/or restricting the resource to a physical and/or virtual implementation. A number of different types of generic resource providers can be available for use in a given service design including, for example, server resources, network structures, data storage, software applications, monitoring, and management interfaces.

In a number of examples, a specific resource provider (e.g., specific resource provider 118-1), can be selected from a plurality of available specific resource providers (e.g., 118-1, 118-2, . . . 118-N). As used herein, a specific resource provider refers to a specific set of physical and/or virtual cloud resources that can be used to perform an associated function, and unlike a generic resource provider, is tied to a specific location and type of resource. For instance, both physical and virtual servers can represent specific resource providers for a generic server (e.g., a generic resource provider of a server type), and one specific server resource that might be associated with a generic server may include a physical server assembly located in a particular data center. Once the specific resource provider (e.g., 118-1) is selected, the service component 102 can instruct each generic resource provider (e.g., 108) to implement all public actions exposed by the selected specific resource provider 118-1, effectively transforming it into an instantiation of the specific resource provider 118-1. Selection of a specific resource provider for each generic resource provider (e.g., 108) can be performed based on a number of parameters derived from the service design. The selection can be based on a rule-based determination of an appropriate specific resource provider for each generic resource provider.

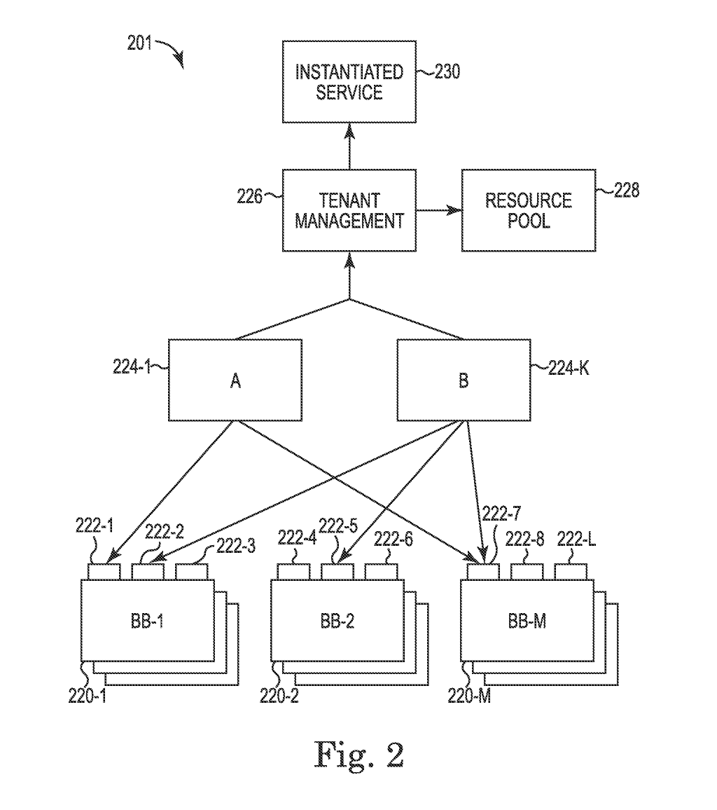

FIG. 2 illustrates an example of an environment 201 for providing network resources according to the present disclosure. The environment 201 can include a service design that creates a number of building blocks (“BB”) BB-1 220-1, BB-2 220-2, . . . , BB-M 220-M (e.g., server, storage, network, security, application install, etc.). Each building block can include a number of resource offerings that are offered on a number of sub-portions of building blocks 222-1, 222-2, and 222-3 on BB-1 220-1; 222-4, 222-5, and 222-6 on BB-2 220-2; and 222-7, 222-8, . . . , 222-L on BB-M 220-M. A resource offering can include capabilities of the building blocks such as storage capacity, processing speed, etc. A sub-portion of the building block can include a resource offering. A first instantiated service application (e.g., Application A 224-1) can use resource offerings that are offered on a number of sub-portions (e.g., “slices”) of a resource (e.g., sub-portions 222-1 and 222-7). A second instantiated service application (e.g., Application B 224-K) can use a number of resource offerings on a number of sub-portions (e.g., sub-portions 222-2, 222-5, and 222-7). In accordance with the present disclosure, the number of slices of a resource in this example are illustrative only. The number of slices and/or resources used are not so limited. An application can use a slice of a resource, a whole resource, or multiple slices of resources.

The definition of a number of applications (e.g., Application A 224-1 and Application B 224-K) is input into a tenant management component 226. The definition of an application can include the building blocks the application uses and/or capabilities of the application. The tenant management component can include software, hardware, and/or logic to manage a number of tenants and the tenants' requests for access to resources. The tenant management component 226 is in communication with a resource pool 228 that tracks a number of instantiated services (e.g., server, storage, network, security, database, application server, web server, load balancer, etc.). The instantiated services can include Application A 224-1 and Application B 224-K. The tenant management component 226 can use information from the resource pool 228 to determine an instantiation of a service to provide for the tenant (e.g., instantiated service 230 received by the tenant). The resource pool 228 can include resources that may be already instantiated. If the resource pool 228 does not include an instantiated resource that would meet the request of the tenant for a resource, a resource could be instantiated that was not previously instantiated.

A building block can be instantiated to offer a service (e.g., instantiated service 230) to a user based on a tenant associated with the user. For example, a building block can be instantiated in response to a request from a first user of a first tenant. The building block can be instantiated to a second user of the first tenant with a same and/or similar parameters. The building block can be instantiated to a third user of a second tenant but with different parameters with respect to differences between the tenants. For example, a first tenant can have different security access to particular files and/or services than a second tenant. The building block can still be instantiated to provide a multi-tenant service but with respect to the differences between tenants. A generic resource provider can use the parameters associated with different users and/or associated different tenants as input to a service design to determine which specific resource provider to select to instantiate the service.

The instantiated service 230 can include a “per tenant” slice of a resource for each resource definition. For example, a user of a tenant (e.g., an organization) can request a software application (e.g., application A 224-1). The tenant management component (e.g., 226) can communicate with a resource pool (e.g., 228). The resource pool 228 can indicate that the resource offerings for the requested software application are instantiated on a first building block (BB-1 220-1) and a second building block (BB-M 220-M). The resource offerings use a slice of the building blocks (e.g., resource offering 222-1 and 222-7). The service is instantiated for use by the user using resource offerings 222-1 and 222-7 from the slice of BB-1 220-1 and BB-M 220-M, respectively. The instantiated service can be registered back into the tenant management component 226 as instantiated. The registered instantiation can be used for future requests of resources to determine which resources may be in use and which may not be.

While FIG. 2 shows one instantiated service (e.g., instantiated service 230), the present disclosure is not limited to one instantiated service. For example, a number of tenants can be provided with a number of instantiated services. In one example, a first tenant can request an instance of a first application (e.g., Application A 224-1). A second and third tenant (or a number of tenants) can request the same application. The application can be provided to the first, second, and third tenant by using a same platform that can share common resources (e.g., a database, platform, etc.). For example, a number of application instances of the same application can be provided to a number of tenants using common resources. A multi-tenant application can be provided to a number of tenants that experience the application as if they own the application and are using the resources exclusively even though the resources are being shared in common. The common resources can include a full building block or a sub-portion and/or slice of the building block.

A generic resource provider (e.g., generic resource provider 108 illustrated in FIG. 1) can be used in an abstract design to incorporate parameters and select a specific resource provider (e.g., specific resource provider 118-1 illustrated in FIG. 1). Selection of a specific resource provider, as described in FIG. 1, can be used to select a resource offering, as described in FIG. 2. For example, a representational design can determine a generic resource provider definition based on parameters that would satisfy a request for a resource. The generic resource provider can use these parameters to select resource offerings of building blocks to satisfy the request for a resource. The tenant management component 220 can communicate with a resource pool 228 to monitor instantiated resources for future selection of specific resource providers.

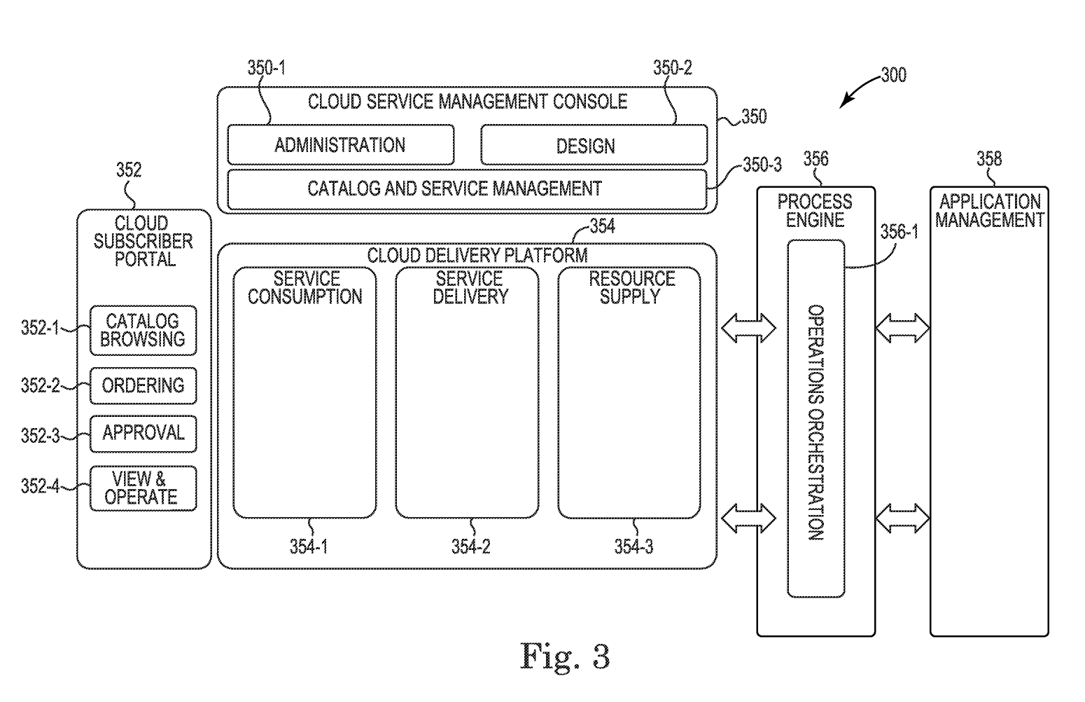

In a number of examples, policy based selection of resources for a cloud service can be implemented in a cloud service management system (e.g., HP Cloud Service Automation (CSA 3.2), for instance). The cloud service management system can orchestrate the deployment of compute and infrastructure resources and complex multi-tier application architectures or any other cloud service described by a blueprint and/or service design. In a number of examples, the cloud service management system can include a catalog-based subscription process. For instance, a subscriber can request particular cloud service offerings to be implemented in a cloud service. In some examples, a subscriber can modify predefined cloud service offerings, wherein the predefined cloud service offerings include pricing and other customer-specific features. The deployment of compute and/or infrastructure resources can be based on a number of tenancy models. The number of tenancy models can include a number of shared and/or isolated resources. For example, resources can be deployed to be shared within a tenant. Resources can be deployed to be shared across tenants (e.g., by users of different tenants). Resources can be deployed to be isolated across tenants and/or shared by a subset of users of different tenants and may not be shared by all users in the different tenants. FIG. 3 illustrates an example of cloud service management for selection of resource providers for multi-tenancy provision of building blocks according to the present disclosure. As shown in FIG. 3, a cloud service management system 300 can include a number of different architectural components (e.g., an example of a cloud service management system can include HP Cloud Service Automation (CSA 3.2)). For instance, the cloud service management system can include a cloud service management portal 350, a cloud subscriber portal 352, a cloud delivery portal 354, a process engine module 356, and a number of application management modules 358.

The cloud service management portal 350 can include hardware and/or a combination of hardware and programming to perform a number of different functions to manage cloud services. For instance, the cloud service management console 350 can perform administrative functions using an administration module 350-1, design functions using a design module 350-2, and/or management functions using a catalog and service management module 350-3. The cloud subscriber portal 352 can include hardware and/or a combination of hardware and programming to perform a number of different functions supporting a cloud subscriber. For example, the cloud subscriber portal can perform functions allowing a cloud subscriber to browse a cloud service catalog (e.g., using a catalog browsing module 352-1), order cloud services (e.g., using an ordering module 352-2), approve cloud service offerings (e.g., using an approval module 352-3), and/or view subscriptions (e.g., using a view and operate module 353-3).

The cloud delivery platform 354 can include hardware and/or a combination of hardware and programming to perform a number of different functions to deliver cloud services. For instance, the cloud delivery platform 354 can include a service consumption sub-module 354-1 including information on cloud service pricing, a catalog of cloud services available, a number of offerings, and/or subscriptions to cloud services. The service consumption sub-module 354-1 can determine a tenancy and how that tenancy consumes resources. Similarly, the cloud service delivery platform 354 can include a service delivery sub-module 354-2 that can include information on service blueprints, cloud service components, instances, and/or bindings. Further, the cloud service delivery platform 354 can include a resource supply sub-module 354-3 that can include information on resource pools, cloud service providers, cloud service offerings, and/or cloud service subscriptions. The resource supply sub-module 354-3 can show how a building block is exposed through a resource provider (e.g., how a resource provider is providing resources using building blocks). The resource supply sub-module 354-3 can show how the resource provider layer manages registration and/or selection of building blocks and/or services in order to provide a service to a user of a tenant.

In a number of examples, the cloud management system 300 can include a process engine 356. The process engine 356 can include hardware and/or a combination of hardware and programming to orchestrate cloud service management operations (e.g., using an operations orchestration module). For instance, process engine 356 can use a generic resource provider to dynamically select service providers (e.g., resource providers) based on a number of policies. Further, the cloud management system 300 can include an application management system 358. The application management system 358 can include hardware and/or a combination of hardware and programming to manage applications. Managing applications and/or resources can include providing shared and/or isolated resources (e.g., through service consumption 354-1 and/or service delivery 354-2) and/or sub-portions of the shared resources through resource providers to instantiate the shared and/or isolated resources and/or sub-portions of the shared and/or isolated resources. The particular characteristics of a tenancy can be determined The shared and/or isolated resources can be provided by using a generic provider to select a specific resource provider based on parameters associated with a tenant and/or a number of tenants. The provided resources can be managed and/or monitored (e.g., through application management 358) as resources are consumed, updated, and/or changed throughout a life cycle of each resource provided.

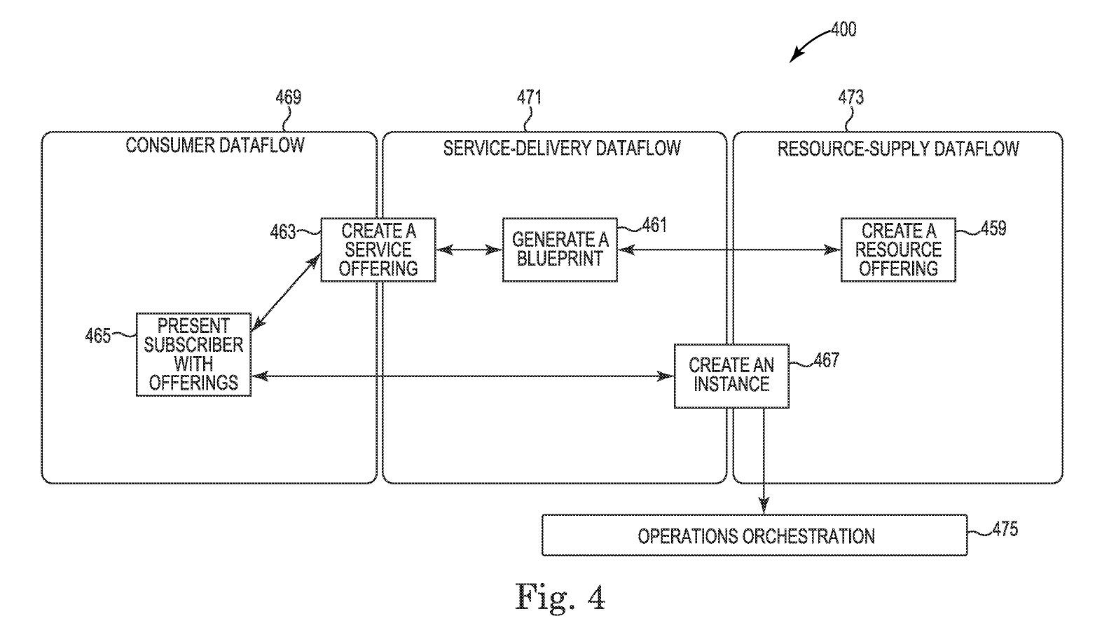

FIG. 4 illustrates an example of a flow chart for selection of resource providers for multi-tenancy provision of building blocks according to the present disclosure. As shown in FIG. 4, a cloud service management system 400 can manage the flow of information between a subscriber (e.g., via a consumer dataflow 465), a cloud service (e.g., via a service-delivery dataflow 466), and resource providers (e.g., via a resource-supply dataflow 467). For example, at 460, the cloud service management system 400 can generate a resource offering. Generating a resource offering can include creating and/or importing resource offerings from underlying resource providers. At 461, the cloud service management system 400 can generate a service blueprint. Generating a service blueprint can include designing a cloud service, including the configuration, topology, behaviors, resource bindings, and/or service options included in the cloud service. At 462, the cloud service management system 400 can create a service offering. Creating a service offering can include defining pricing for the particular cloud service, defining a number of options related to the cloud service, defining default options related to the cloud service, and/or defining SLA documents related to the cloud service, for instance.

At 463, the cloud service management system 400 can present a subscriber with service offerings for review, approval, and subscription. To create a service offering at 463, the cloud service management system 400 can include a particular characteristic about a tenant in order to create and/or provide the service offering to the tenant. At 464, the cloud service management system 400 can create an instance of the particular service offerings. Creating an instance of the particular service offerings can include selecting a service component, binding a resource to provide the cloud service, and/or generating a resource subscription. In a number of examples, the instance of the particular service offering and/or the resource subscription for the particular service offerings can be sent to an operations orchestrator 468 for implementation. In some examples, a generic resource provider can be used to select a specific resource provider based on a number of policies. For instance, the operations orchestrator can use a rule-based algorithm to select a specific resource provider. At 475, an operations orchestration can include an orchestration of how services are being provided. The operations orchestration, at 475, can include registering a building block and/or a provided service as being consumed by a tenant and/or user of a tenant. The operations orchestration, at 475, can include selecting a building block to provide a service and/or a service based on tenant policies, service consumption, service instantiation, etc.

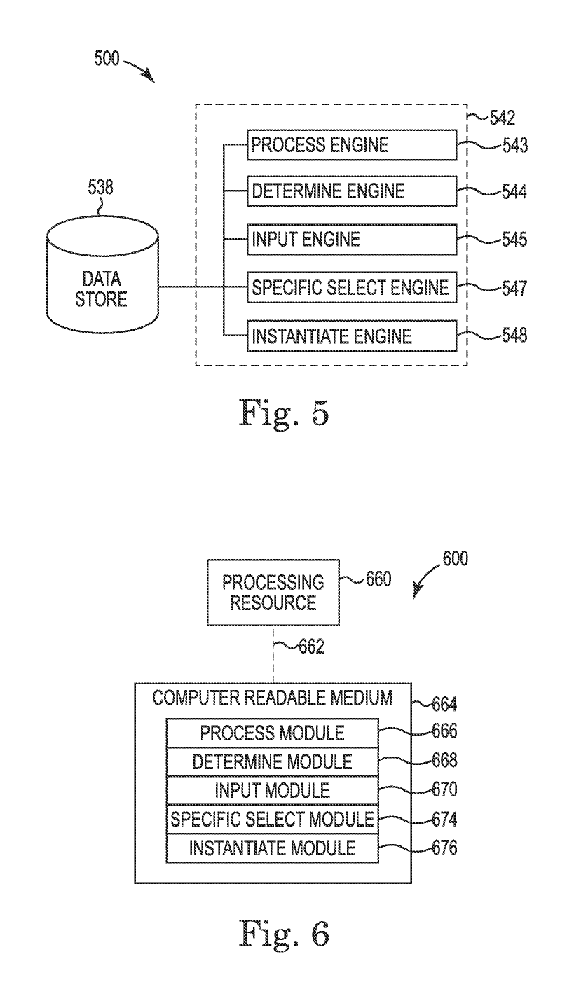

FIG. 5 illustrates an example of a system 500 for selection of resource providers for multi-tenancy provision of building blocks according to the present disclosure. The system 500 can include a data store 538, providing system 542, and/or a number of engines 543, 544, 545, 547, 548. The selecting system 342 can be in communication with the data store 538 via a communication link, and can include the number of engines (e.g., process generate engine 543, determine engine 544, input engine 545, specific select engine 547, and instantiate engine, etc.). The selecting system 542 can include additional or fewer engines than illustrated to perform the various functions described herein.

The number of engines can include a combination of hardware and programming that is configured to perform a number of functions described herein (e.g., define a number of configurable rules based on a number of parameter values). The programming can include program instructions (e.g., software, firmware, etc.) stored in a memory resource (e.g., computer readable medium, machine readable medium, etc.) as well as hard-wired program (e.g., logic).

The process engine 543 can include hardware and/or a combination of hardware and programming to process a request for services from users of a plurality of tenants. A user can request a service based on a need of a tenant. A number of users of a tenant can request a same and/or similar and/or different services.

The determine engine 544 can include hardware and/or a combination of hardware and programming to determine parameters to input into the service designs based on each of the requests and each of the corresponding tenants. The parameter can be used to describe a tenancy policy of a tenancy model. The parameter can include information specific to a tenant. The parameter can include tenant sharing information. A request from a user can include a parameter based on the tenant the user belongs to. A parameter can include a particular aspect of the service that the user is requesting. A parameter can include a particular operating capability of the service. A parameter can be input into a service design to determine which generic resource provider to select to provide the service to the user requesting the service. A parameter can include information associated with a tenant. For example, a parameter can include particular access rights a tenant may have in association with a particular resource. A parameter can include a relationship a first tenant has to a second tenant (e.g., how the tenants may share information, which information to share, etc.).

The input engine 545 can include hardware and/or a combination of hardware and programming to input determined parameters into a service design. A parameter can be entered into a service design to determine actions to perform based on the input parameters. The actions can provide the service to the user of a tenant. The service design can use the parameters to determine how to provide the service to the user and which resource providers to select to provide the service. A generic resource provider can be used based on the parameters (e.g., a business policy and/or QoS parameters) to select a resource provider to provide services. The generic resource provider can use center constraints to determine a specific resource provider. Center constraints can include a constraint on a center that the resource may be located in. For example, a parameter of a resource for a user may include a level of security, a location of the resource, a capacity requirement, a processing ability, etc. A center including resources may have a particular level of security, a particular location, resources with a particular capacity and/or processing ability. The specific resource provider selected can be in the center with the particular parameters that the user is requesting.

The specific select engine 547 can include hardware and/or a combination of hardware and programming to select a specific resource provider of the building blocks at run time based on the parameters and the service design. The parameters can include business policies and/or quality of service (QoS) parameters. The selection can be based on a parameter including dependency tracking between various building blocks and composite service definitions (e.g., dependencies such as use-of, part-of, depends-on, requires, etc. but are not limited to such aforementioned dependencies). The selection can be based on tenancy policies such as tenancy characteristics and/or tenancy sharing characteristics across, between, and/or among different tenants. For example, a first tenant may want to share a first set of information with a second tenant and not share a second set of information with the second tenant. The selection can be based on this sharing information. The specific select engine 547 can use a generic resource provider to determine a specific resource provider.

The instantiate engine 548 can include hardware and/or a combination of hardware and programming to instantiate a building block to a user. The building block can be instantiated through a specific resource provider selected by a generic resource provider. The generic resource provider can be determined based on parameters input to a service design. The service design can input information to instantiate a building block.

The number of engines can include a management engine. The management engine can include hardware and/or a combination of hardware and programming to manage a life cycle of a building block. The service design can input information to update resource providers based on changes to a request, changes to a service design, and/or changes to an overall provisioning of resources to meet particular parameters and/or demands of the system. A management of a lifecycle of the resources can be provided in order to instantiate new building blocks if none are instantiated to provide a particular service or to de-provision a building block (e.g., terminate an instantiation of a building block) if the building block is no longer requested and/or no longer needed to provide a resource.

FIG. 6 illustrates an example of a system 500 for selection of resource providers for multi-tenancy provision of building blocks according to the present disclosure. The computing device 600 can be any combination of hardware and program instructions configured to share information. The hardware for example can include a processing resource 660 and/or a memory resource 664 (e.g., computer-readable medium (CRM), machine readable medium (MRM), database, etc.) A processing resource 660, as used herein, can include any number of processors capable of executing instructions stored by a memory resource 664. Processing resource 660 may be integrated in a single device or distributed across multiple devices. The program instructions (e.g., computer-readable instructions (CRI)) can include instructions stored on the memory resource 364 and executable by the processing resource 660 to implement a desired function (e.g., to define a number of rules based on a number of parameter values).

The memory resource 664 can be in communication with a processing resource 360. A memory resource 664, as used herein, can include any number of memory components capable of storing instructions that can be executed by processing resource 660. Such memory resource 664 can be a non-transitory CRM or MRM. Memory resource 664 may be integrated in a single device or distributed across multiple devices. Further, memory resource 664 may be fully or partially integrated in the same device as processing resource 660 or it may be separate but accessible to that device and processing resource 660. Thus, it is noted that the computing device 600 may be implemented on a participant device, on a server device, on a collection of server devices, and/or a combination of the user device and the server device.

The memory resource 664 can be in communication with the processing resource 660 via a communication link (e.g., a path) 662. The communication link 662 can be local or remote to a machine (e.g., a computing device) associated with the processing resource 660. Examples of a local communication link 662 can include an electronic bus internal to a machine (e.g., a computing device) where the memory resource 664 is one of volatile, non-volatile, fixed, and/or removable storage medium in communication with the processing resource 660 via the electronic bus.

A number of modules 666, 668, 670, 674, 676 can include CRI that when executed by the processing resource 360 can perform a number of functions. The number of modules 666, 668, 670, 674, 676 can be sub-modules of other modules. For example, the process module 666 and the determine module 668 can be sub-modules and/or contained within the same computing device. In another example, the number of modules 666, 668, 670, 674, 676 can comprise individual modules at separate and distinct locations (e.g., CRM, etc.).

Each of the number of modules 666, 668, 670, 674, 676 can include instructions that when executed by the processing resource 660 can function as a corresponding engine as described herein. For example, the generate module 666 can include instructions that when executed by the processing resource 660 can function as the generate engine 643. In another example, the register module 668 can include instructions that when executed by the processing resource 660 can function as the register engine 644.

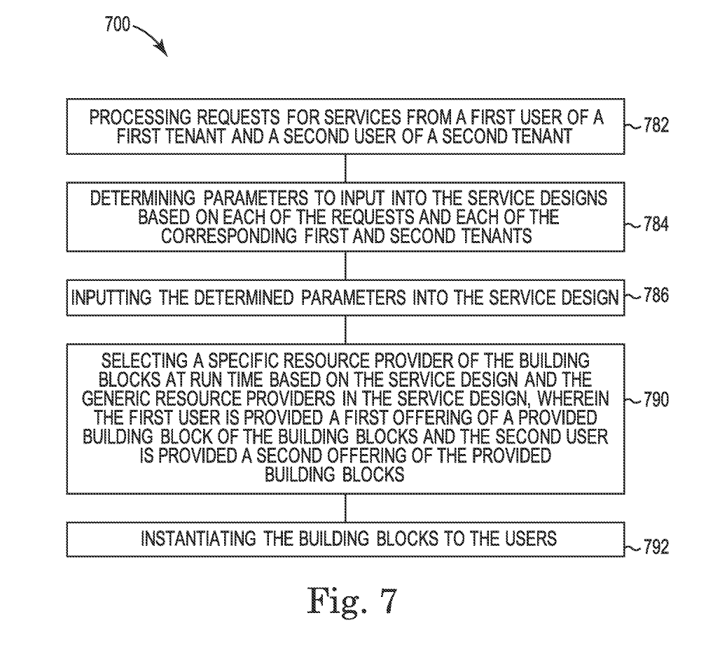

FIG. 7 illustrates a flow diagram of an example method 700 for providing network resources according to the present disclosure. The method 700, can include, at 782, processing requests for services from a first user of a first tenant and a second user of a second tenant. The requests can include a request for a particular application. Each user can request a different application that uses a same building block and/or the users can request a same application that uses the same building block. The users can request a same application that can be provided by two different building blocks. The users can request different applications that are provided by different building blocks. The requested services can be provided by a sub-portion of a building block.

At 784, the method 700 can include determining parameters to input into the service designs based on each of the requests and each of the corresponding first and second tenants. A parameter can designate how to provide a requested service based on a tenant associated with the user requesting the service. For example, a tenant associated with a user can have particular security clearance and/or budget allowance for services. Services can be partitioned for the tenant's use based on the security clearance and/or the budget constraints. The parameter of the resource provider can include a business policy and/or Quality of Service (QoS) parameter associated with the resource provider. A determination can be made whether an already instantiated building block can meet a request that includes a parameter. For example, a user can request an application. A determination can be made as to whether a first building block can offer the first application based on the parameters of the requested application. If the building block either does not have the capability to offer the requested application or does not have the capacity because it is already offering the application and cannot offer any more resources of the application, performing a determination on an additional building block can occur.

At 786, the method 700 can include inputting the determined parameters into the service designs. A service design can be determined based parameters entered through a request from a user. A service design can be determined based on parameters from a non-user that includes parameters of the system such as building block criteria, provided application criteria, etc. For example, the service design can be based on the processing capability of a building block and/or the processing requirements of an application being provided.

At 790, the method 700 can include selecting a specific resource provider of a building block at run time based on a service design and a parameter. in the service design. The parameter can be designated by a user. The parameters can include business policies and/or quality of service (QoS) parameters. The selection can be based on dependency tracking between various building blocks and composite service definitions (e.g., dependencies such as use-of, part-of, depends-on, requires, etc. but are not limited to such aforementioned dependencies). A first user can be provided with a first offering of a provided building block of a number of building blocks and a second user can be provided with a second offering of the provided building block. A generic resource provider can be used to identify parameters (e.g., a business policy and/or QoS parameters) of the resource provider. The generic resource provider can use center constraints to determine the specific resource provider.

At 792, the method 700 can include instantiating a building block to users. The selected specific resource provider can be instantiated to provide the application to the users. The instantiation can include providing a resource offering of the resource provider to the users. The instantiation of the building block can include deploying the building block and/or executing operation of the building block for use by the user. The instantiated building block can be managed. Managing the a building block can include registering the building block. Registering can include registering a building block as a resource provider and a definition of the building block. The definition of the building block can be registered with an orchestrator. The type and capabilities (e.g., resource offerings) of the building block can be known to the orchestrator by registering the definition of the building block. By registering the building block as a resource provider, the orchestrator can use the building block for additional resource allocation to fully use the building block. The orchestrator can know the type and/or capabilities of the instantiated building block. The registering of the instantiation of the building block can allow the orchestrator to use the instantiated building block to provide an additional application and/or access to a service to an additional user and/or tenant. The reallocation of an already instantiated resource provider can allow for recursive use of the resource in a multi-tenancy environment.

The combination of a multi-tenancy environment using a generic resource provider can allow an application and a database to be associated with a number of tenants in an efficient use of resources without compromising security. The building block pool can dynamically expand or contract based on usage. Dependencies between building blocks can be monitored. Different instances of the same application can be used by different sub-portions of the same building block.

In the detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be used and the process, electrical, and/or structural changes may be made without departing from the scope of the present disclosure.

In addition, the proportion and the relative scale of the elements provided in the figures are intended to illustrated the examples of the present disclosure, and should not be taken in a limiting sense. As used herein, the designators “N” and “P,” particularly with respect to reference numerals in the drawings, indicate that a number of the particular feature so designated can be included with a number of examples of the present disclosure.

What is claimed:

1. A non-transitory computer-readable medium storing a set of instructions executable by a processing resource to:
process requests for services from users of a plurality of tenants;
determine parameters to input into a service design based on each of the requests and each of the corresponding tenants;
input the determined parameters into the service design; and
select a specific resource provider of building blocks that support services at run time based on the parameters and the service design; and
instantiate the building blocks.

2. The medium of claim 1, including instructions to manage a life-cycle of the service design that are executable by the processing resource to:
manage the building blocks; and
update one of a registration, a status, an availability, and a set of information associated with the building blocks.

3. The medium of claim 1, wherein selection of the specific resource provider is performed by a generic resource provider based on the service design.

4. The medium of claim 1, wherein the building blocks provided by the resource provider include building blocks already instantiated for an additional user of the tenant and the building blocks are shared to provide the service to the user and the additional user.

5. The medium of claim 1, wherein the building blocks provided by the resource provider include building blocks already instantiated to an additional user of a same tenant that provides a same access for the service provided.

6. The medium of claim 1, wherein the building blocks provided by the resource provider include building blocks already instantiated to an additional user of a different tenant that provides different access for the service provided.

7. The medium of claim 1, wherein the set of instructions are executable by the processing resource to register the building blocks as instantiated when the building blocks are instantiated to the user.

8. The medium of claim 1, wherein the set of instructions are executable by the processing resource to update the registration of the building blocks when a detail of the instantiated service changes an availability of the building blocks.

9. A system for managing tenants through building block selection, comprising a process engine, a determine engine, an input engine, a generic select engine, a specific select engine, and an instantiate engine, wherein:
the process engine processes requests for services from users of a plurality of tenants;
the determine engine determines parameters to input into service designs based on each of the requests and each of the corresponding tenants;
the input engine inputs the determined parameters into the service designs to be executed;
the specific select engine selects a specific resource provider of the building blocks at run time based on the associated parameters and the associated service designs, wherein a first user of the users is from a first tenant and a second user of the users is from a second tenant and the first user and the second user share building blocks to provide a multi-tenant application; and
the instantiate engine instantiates the building blocks to the users.

10. The system of claim 9, including a manage engine that manages a life-cycle of the service design, wherein the manage engine:
manages the building blocks; and
updates one of a registration, a status, an availability, and a set of information associated with the building blocks.

11. The system of claim 9, wherein the specific resource provider is selected by a generic resource provider based on the parameters.

12. The system of claim 9, comprising a register engine that registers the building blocks as instantiated and provided to the users of the plurality of tenants.

13. The system of claim 9, comprising an update engine to update the service design based on a request from the requests being changed and to update the provision of the building blocks based on the updated service design.

14. The system of claim 9, comprising a release engine to release a building block of the instantiated building blocks when a requested service is no longer in use.

15. A method for tenancy management by selection of building blocks, comprising:
processing requests for services from a first user of a first tenant and a second user of a second tenant;
determining parameters to input into service designs based on each of the requests and each of the corresponding first and second tenants;
inputting the determined parameters into each of the associated service designs;
selecting a specific resource provider of the building blocks at run time based on each of the service designs and the generic resource providers in each of the associated service designs, wherein the first user is provided a first offering of a provided building block of the building blocks and the second user is provided a second offering of the provided building block; and
instantiating the building blocks to the users.

16. The method of claim 15, comprising:
managing a lifecycle of the building blocks; and
updating one of a registration, a status, an availability, and a set of information associated with the building blocks.

17. The method of claim 15, wherein selecting the specific resource provider is performed by a generic resource provider based on each of the service designs that include the associated parameters.

18. The method of claim 15, wherein instantiating of the building blocks to the users comprises instantiating an additional building block that was not previously instantiated based on the parameters in the service design.

19. The method of claim 15, wherein the selecting of the specific resource provider of the building blocks at run time comprises selecting a specific resource provider that provides a building block as a shared resource from a pool of building blocks already available through the resource provider when the requested service depends on other services that are building blocks already instantiated.

20. The method of claim 15, comprising updating the parameters in the service design and updating registered building blocks based on additional use of the registered building blocks by tenants or tenants ending use of the registered building blocks and managing a lifecycle of changes to the registered building blocks.
